(19) United States
(12) Patent Application Publication
(10) Pub. No.: US 2012/0266824 A1
(43) Pub. Date: Oct. 25, 2012

(54) DISPOSABLE HANGABLE ANIMAL FOOD DISPENSER

(75) Inventors: Michael Trauttmansdorf, Jerseyville (CA); Thomas Trauttmansdorf, Jerseyville (CA)

(73) Assignee: 1255722 ONTARIO INC., Jerseyville, Ontario (CA)

(21) Appl. No.: 13/503,079

(22) PCT Filed: Sep. 2, 2010
(86) PCT No.: PCT/CA2010/001379

§ 371 Date: Jul. 9, 2012

(30) Foreign Application Priority Data
Oct. 21, 2009 (CA) 2683364

(51) Int. Cl. A01K 5/00

(52) U.S. Cl. 119/65

(57) ABSTRACT

Provided is an animal food dispenser for dispensing food to animals such as rabbits. The dispenser comprises a package for holding the animal food; an attachment means secured to the package for attaching the animal food dispenser to an enclosure and reconfigurable to adapt to different types of enclosures, such as a rabbit cage; a window through the package; and a window cover removeably attachable to the package for covering the window. The window cover is at least partially removable from the package to provide access through the window to the animal food held in the package.

### FIELD OF THE INVENTION

The present invention relates to food dispensers and in particular to disposable hangable food dispensers.

### BACKGROUND OF THE INVENTION

Food for domesticated animals is commonly sold in portable packages. For example, hay or other animal food may be sold for feeding rabbits and other small pets (e.g. guinea pigs, chinchillas) who live in cages or similar enclosures. Often these packages must be opened and the food removed and placed in a bowl, on the floor or in a separate feeding dispenser inside or nearby the domesticated animals' habitat (e.g. a cage or similar enclosure).

Transferring hay from the package to the desired feeding location can be messy because leaves and small particles can fall out of the hay bulk while it is handled. In addition, hay can be rough and unpleasant to handle, can trigger allergies in humans, and some of it inevitably gets soiled and wasted on the floor of the cage. The food package must be resealed and stored away from the animal when the food package is not empty and not in use.

The present invention solves at least one of the above problems.

### SUMMARY

In accordance with an aspect of the present invention, there is provided an animal food dispenser for dispensing food, comprising: a package for holding the animal food; an attachment means secured to the package, the attachment means for attaching the animal food dispenser to an enclosure, the attachment means reconfigurable to adapt to different types of enclosures; a window through the package; and a window cover removeably attachable to the package for covering the window, the window cover at least partially removable to provide access through the window to the animal food held in the package.

In accordance with an aspect of the present invention, the package is a flexible material.

In accordance with an aspect of the present invention, the package is a rigid material.

In accordance with an aspect of the present invention, the package is a cardboard box.

In accordance with an aspect of the present invention, the window cover remains permanently attached to a portion of the package.

In accordance with an aspect of the present invention, the animal food is hay.

In accordance with an aspect of the present invention, the window cover comprises a transparent surface, the transparent surface covering at least a portion of the window on the package.

In accordance with an aspect of the present invention, the window cover is removeably attachable using adhesive.

In accordance with an aspect of the present invention, the window cover is removable from the package using a perforation in the package.

In accordance with an aspect of the present invention, the window cover comprises: a material strip, the material strip circumnavigates the package, the material strip is secured over the window of the package by a friction fit.

In accordance with an aspect of the present invention, the package has an aperture for receiving the animal food.

In accordance with an aspect of the present invention, the attachment means at least initially secures the aperture shut.

In accordance with an aspect of the present invention, the aperture is secured shut by adhesive.

In accordance with an aspect of the present invention, the aperture is resealable using the attachment means.

In accordance with an aspect of the present invention, the attachment means is a conformable and pliable ribbon.

In accordance with an aspect of the present invention, the attachment means is a deformable strip attached substantially at the edge of the aperture.

In accordance with an aspect of the present invention, the enclosure is an animal cage.

In accordance with an aspect of the present invention, the package is disposable.

In accordance with an aspect of the present invention, there is provided a method of dispensing animal food from an animal food dispenser, comprising: providing an animal food dispenser as defined above; attaching the package to the interior of the enclosure; and removing the window cover from the package.

In accordance with an aspect of the present invention, the package is removed from the interior of the enclosure and disposed of.

At least one advantage of the present invention is that it keeps uneaten hay clean, and reduces the mess, waste, discomfort, and repetitive effort that come with manually taking hay from the package and placing it into the cage/feeder every day.

### BRIEF DESCRIPTION OF THE DRAWINGS

In order that the subject matter may be readily understood, embodiments are illustrated by way of examples in the accompanying drawings, in which:

FIG. 1A is a perspective view of a hay dispenser in accordance with an exemplary embodiment of the invention;

FIG. 1B is a perspective view of a hay dispenser with the cover partly removed in accordance with an exemplary embodiment of the invention;

FIG. 1C is a perspective view of a hay dispenser with the cover fully removed in accordance with an exemplary embodiment of the invention;

FIG. 2 is a perspective view of a hay dispenser attached to an enclosure in accordance with an exemplary embodiment of the invention;

FIG. 3 is a perspective view of a hay dispenser in its open unfilled position in accordance with an exemplary embodiment of the invention;

FIG. 3A is a perspective view of a hay dispenser in its open unfilled position in accordance with another exemplary embodiment of the invention;

FIG. 4 is a perspective view of a hay dispenser in its open filled position in accordance with an exemplary embodiment of the invention;

FIG. 4A is a perspective view of a hay dispenser in its closed filled position in accordance with an exemplary embodiment of the invention;

FIG. 5 is a perspective view of a hay dispenser with a material strip cover in accordance with an exemplary embodiment of the invention;

FIG. 6 is a perspective view of a material strip cover in accordance with an exemplary embodiment of the invention;

FIG. 7 is a perspective view of a material strip cover with a package shown in dashed lines in accordance with an exemplary embodiment of the invention;

FIG. 8 is a perspective view of a hay dispenser in accordance with an exemplary embodiment of the invention;

FIG. 9 is a perspective view of a hay dispenser secured to an enclosure in accordance with an exemplary embodiment of the invention;

FIG. 10A is a perspective view of a hay dispenser in accordance with an exemplary embodiment of the invention;

FIG. 10B is a perspective view of a portion of a hay dispenser and a portion of a bar of an enclosure in accordance with an exemplary embodiment of the invention;

FIG. 10C is a perspective view of a portion of a hay dispenser and a portion of a bar of an enclosure in accordance with an exemplary embodiment of the invention;

FIG. 10D is a cut-away cross-sectional view showing one embodiment of a conformable and pliable ribbon attached to a hay dispensing package in accordance with an exemplary embodiment of the invention;

FIG. 11A is a perspective view of a hay dispenser in accordance with an exemplary embodiment of the invention;

FIG. 11B is a perspective view of a portion of a hay dispenser and a bar of an enclosure in accordance with an exemplary embodiment of the invention;

FIG. 11C is a perspective view of a portion of a hay dispenser and a bar of an enclosure in accordance with an exemplary embodiment of the invention;

FIG. 11D is a cut-away cross-sectional view showing an embodiment of a conformable and pliable ribbon attached to a hay dispensing package in accordance with an exemplary embodiment of the invention;

FIG. 11E is a cut-away cross-sectional view showing an embodiment of a conformable and pliable ribbon attached to a hay dispensing package in accordance with an exemplary embodiment of the invention;

FIG. 12 is a cut-away view showing a hay dispenser filled with hay;

FIG. 13 is a cut-away view showing a hay dispenser filled with hay and attached to a bar of an enclosure;

FIG. 14A a perspective view of a hay dispenser showing an exemplary embodiment of the removable cover;

FIG. 14B is a cross-sectional view of a portion of a hay dispenser showing an exemplary embodiment of the removable cover;

FIG. 14C is a cross-sectional view of a portion of a hay dispenser showing an exemplary embodiment of the removable cover;

FIG. 14D is a cross-sectional view of a portion of a hay dispenser showing an exemplary embodiment of the removable cover with the removable cover partially removed;

FIG. 14E is a cross-sectional view of a portion of a hay dispenser showing an exemplary embodiment of the removable cover with the removable cover partially removed; and,

FIG. 15 is a perspective view of a hay dispenser in an enclosure with a rabbit in accordance with an aspect of the invention.

### DETAILED DESCRIPTION

An exemplary embodiment of an animal food dispenser 100 is shown in the Figures. The embodiment shown in the figures is of a hay dispenser 100 for dispensing, however it is recognized that other suitable types of animal food may be stored and dispensed from the dispenser 100. The hay dispenser 100 comprises a package 102 for holding and dispensing hay 114. The package 102 may be made from paper or other suitable material.

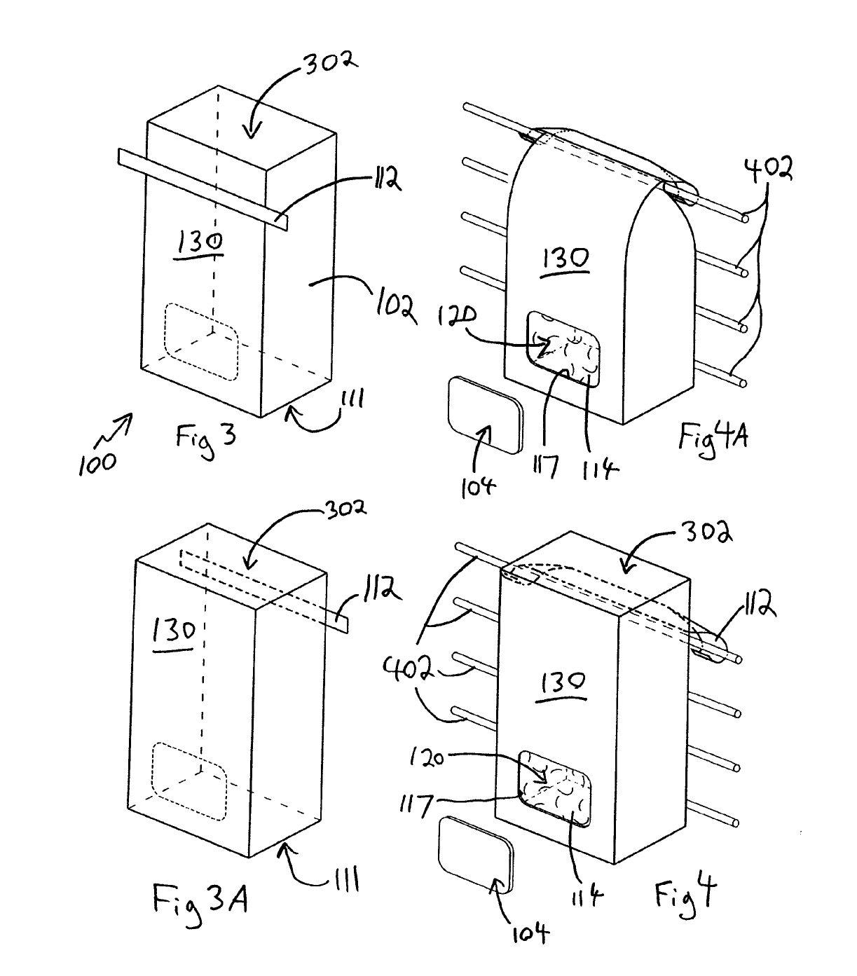

According to an embodiment, the package 102 is pliable and when empty, the package 102 may be folded along perforations 118 and thereby flattened. When filled with hay 114 the package forms a bag or a box with its bottom 111 becoming substantially flat (see FIG. 3, for example).

Referring to FIGS. 3 and 3A, the package 102 has an open top 302 (or “aperture”) for receiving the hay 114. When open, the package 102 is substantially in the shape of a rectangle. The hay 114 may be placed through the open top 302 into the package 102 in order to fill the package 102 with hay 114. It is understood that the package 102 can be of other shapes.

A pliable and conformable ribbon 112 is secured along the upper portion of the front 130 of the package 102 and is parallel to the edge of the package 102. The length of the ribbon 112 is longer than the width of the package 102 so that each end of the ribbon 112 extends beyond each respective side of the package 102.

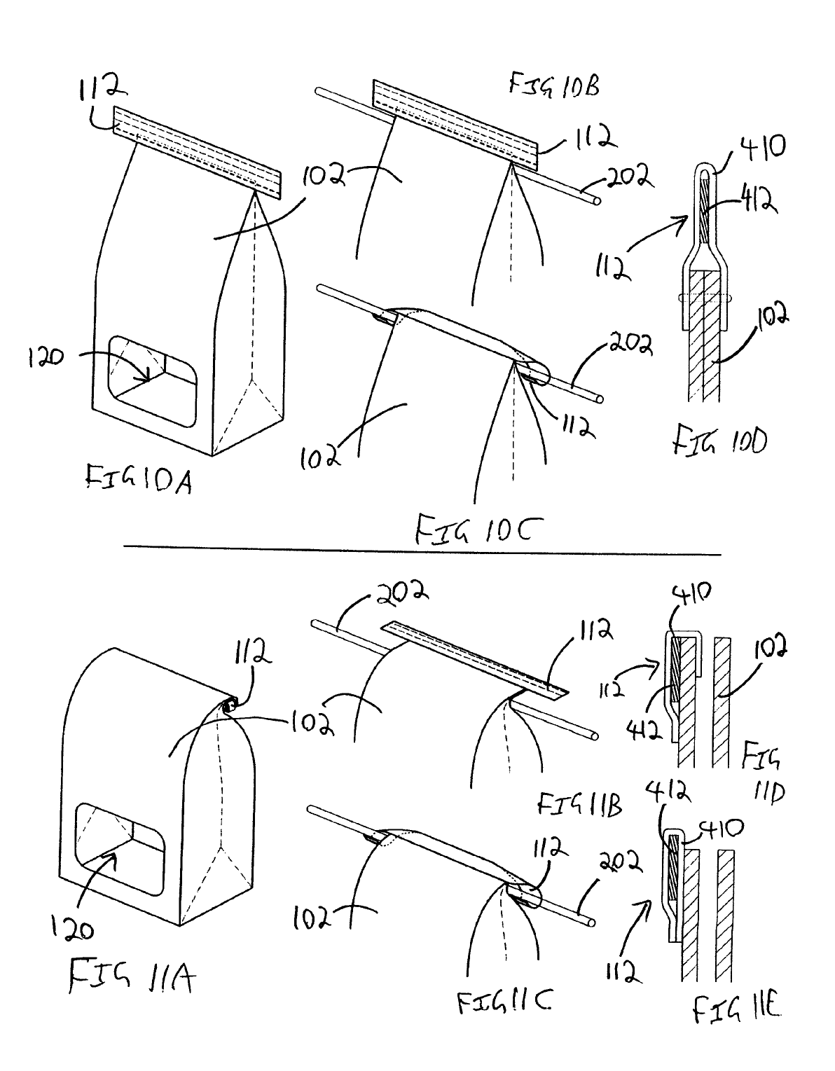

FIGS. 10A to 10D show how the package 102 is closed and supported by a bar 202 using the ribbon 112 according to one embodiment of the invention. According to this embodiment, the ribbon 112 is sealed over the edges of both the front and back sides of the package 102. FIG. 10D shows a cross section of the top edges of each of the front and back sides of the package 102 being secured together with the ribbon 112. The ribbon 112 consists of an outer strip of material 410 surrounding an inner strip of material 412. The outer strip of material 410 is attached to both sides of the package 102 so that it secures together the top opening 302. The inner strip of material 412 is attached to the outer strip of material 410. The outer strip of material 410 may be more pliable than the inner strip of material 412 and the inner strip of material 412 may hold its shape and be stronger than the outer strip of material 410. The outer strip of material 410 may be made of cloth or flexible thin plastic and the inner strip of material may be an aluminum strip or wire, for example. Alternatively, the outer strip of material 410 may be made of paper. Using this embodiment, the package 102 may be filled with hay 114 through the opening 120 or, alternatively, the package 102 may be filled from the top opening 302 prior to the attachment of the ribbon 112.

To attach the package 102 to the bar 202 the ends of the ribbon 112 are each curled around the bar 202 in a reverse bend (shown in FIG. 10C) and snugly secured around the bar 202. Because the ribbon 112 is made of a material that is pliable and conformable, the ribbon 112 will hold its shape when curled around the bar 202, thereby supporting the hay-filled package 102 on the bar 202.

The bar 202 may be on the inside of an enclosure such as a cage for housing a rabbit 299. Once the cover 104 is removed, the rabbit 299 can access the hay 114 in the package 102 through the opening 120 or window of the package 102. The hay dispenser 100 may be disposable. For example, once the rabbit 299 consumes all of the hay 114 from the package 102, the entire dispenser may be recycled or composted or otherwise disposed of.

FIG. 15 shows an embodiment the hay dispenser 100 attached to the interior of an enclosure 155. A rabbit 299 is accessing the hay 114 through the opening or window 120 dispenser 100.

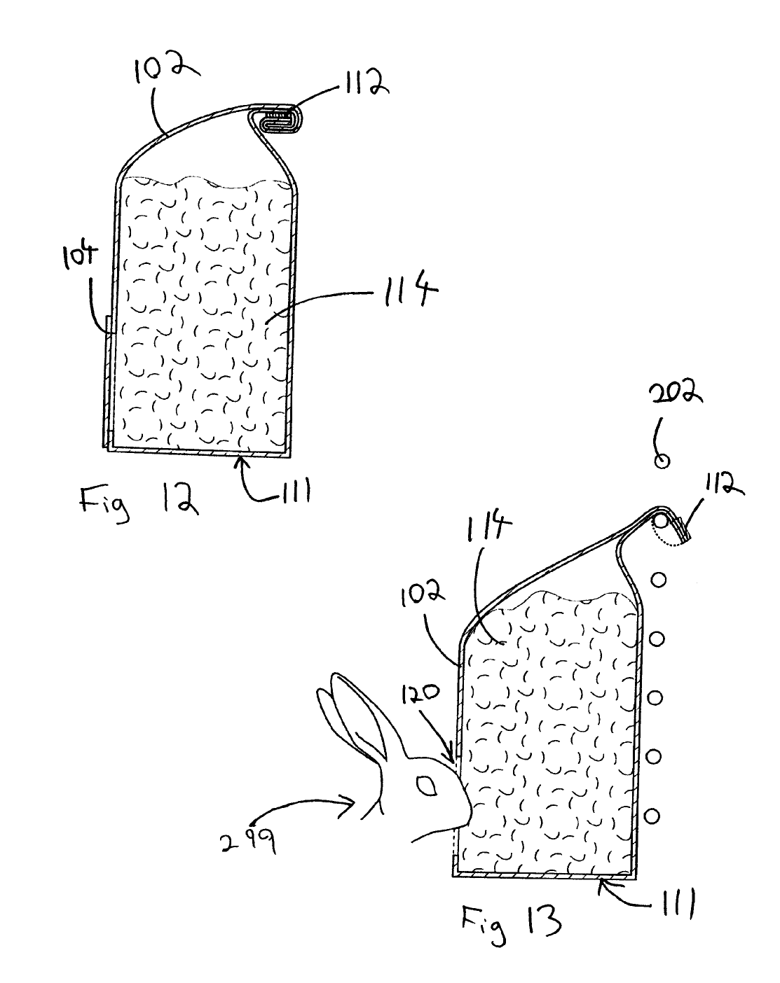

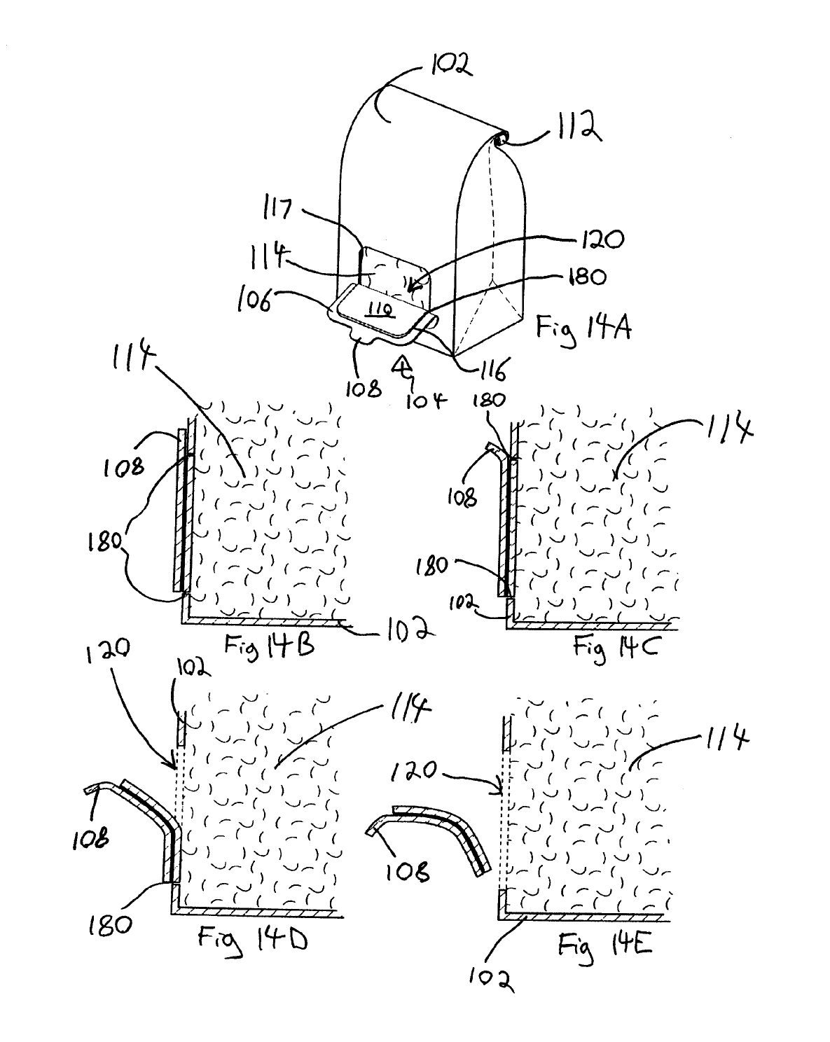

FIGS. 11A to 11E show how the package 102 is closed and supported by a bar 202 using the ribbon 112 according to another embodiment of the invention. This embodiment uses a ribbon made up of an outer strip of material 410 enclosing and attached to an inner strip of material 412 that is attached via a material to one side of the package 102 only. FIGS. 11D and 11E are cross sections of the front and back sides of the package 102 as well as the ribbon 112 and material being attached to only one side of the package 102.

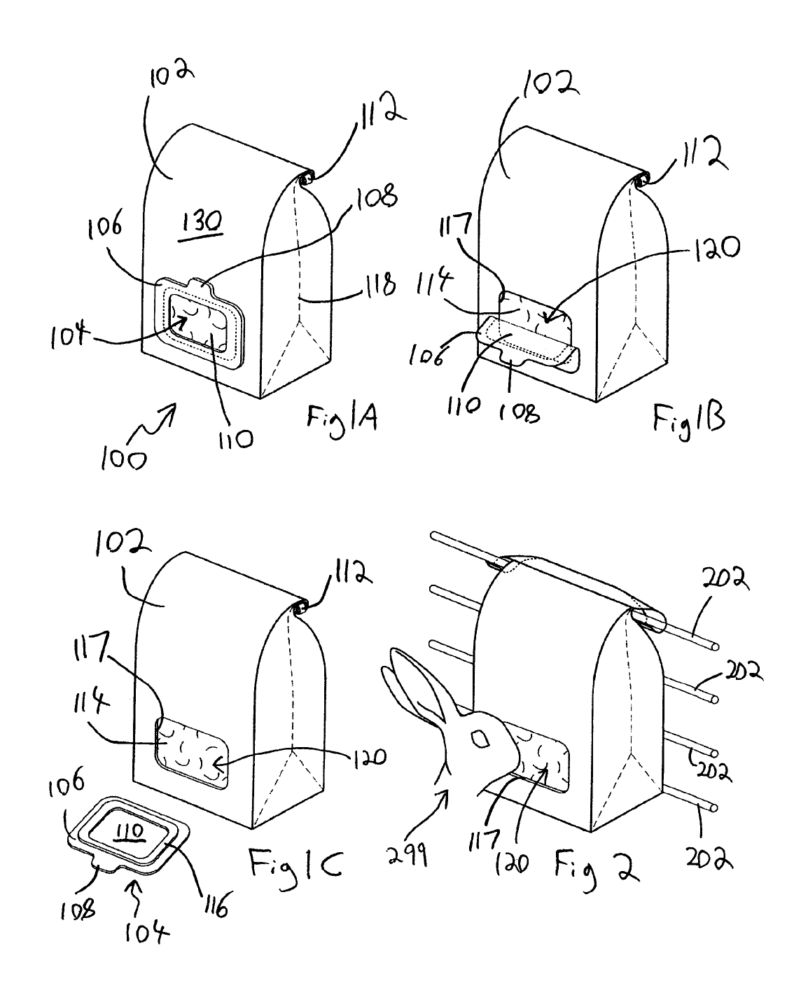

The front 130 of the package 102 has an opening 120 (see FIGS. 1B and 1C) for dispensing hay 114. A cover 104 is releasably attached over the opening 120 to completely obstruct the opening 120 in order to prevent the hay 114 from exiting the package 102. The opening 120 may be referred to as a window 120 and vice versa. Alternatively, the cover 104 may be resealably attached over the opening 120 so that the cover 104 can be removed from the opening 120 and then replaced over the opening. In such a situation a portion of the cover 104 may have a layer of adhesive over it for allowing the cover 104 to attach or adhere to the package 102.

In an alternative embodiment, the window cover 104 remains permanently attached over the opening 120. In order to access the hay 114 through the opening 120 the cover 104 may be folded out of the way of the opening 120 so as to no longer obstruct access to the hay 114.

The ribbon 112 may be on the front side 130 along with the opening 120 (as shown in FIG. 3) or, alternatively, the ribbon 112 may be on the opposite side as the opening 120 (as shown in FIG. 3A).

In another embodiment, the package 102 is made of a rigid material, such as cardboard and forms a container for holding the hay 114. A person of ordinary skill in the art would recognize that other suitable materials may be used to form a rigid package 102. Using a rigid package 102 the aperture or open top 302 may be glued shut using a suitable adhesive. The rigid package 102 may be supported by a bar 202 (e.g. on an enclosure such as a rabbit cage) using at least one attachment means secured to the package 102. The attachment means may be, for example, a ribbon 112 secured to the package 102 for tying the package 102 to a bar.

The package 102 with the cover 104 attached thereto may be stored or transported without losing any hay 114 from the package 102. For example, the package 102 may be displayed on the shelves of a storefront, may be stored in a person's house before being used or may be transported between locations without the loss of any hay 114.

The cover 104 is preferably at least partially transparent so that the hay 114 residing inside the package 102 can be viewed when the cover 104 is attached over the opening 120.

Referring to the embodiment of FIG. 1C, the cover 104 has a transparent central surface 110 sized to at least partly cover or overlap the opening 120. The cover 104 has a ridge 116 extending from the contour of the transparent central surface 110. The ridge 116 fits into the opening 120 so that the ridge abuts the side walls 117 of the opening 120. This assists in keeping the cover 104 in place over the opening 120. An attachment member 106 extends outwardly from the ridge 116 on the opposite side of the ridge 116 as the transparent central surface 110 and is coplanar with the transparent central surface 110. The attachment member 106 has an inside surface facing in the same direction as the ridge 116. The attachment member's 106 inside surface has an adhesive on it for adhering the cover 104 to the package 102.

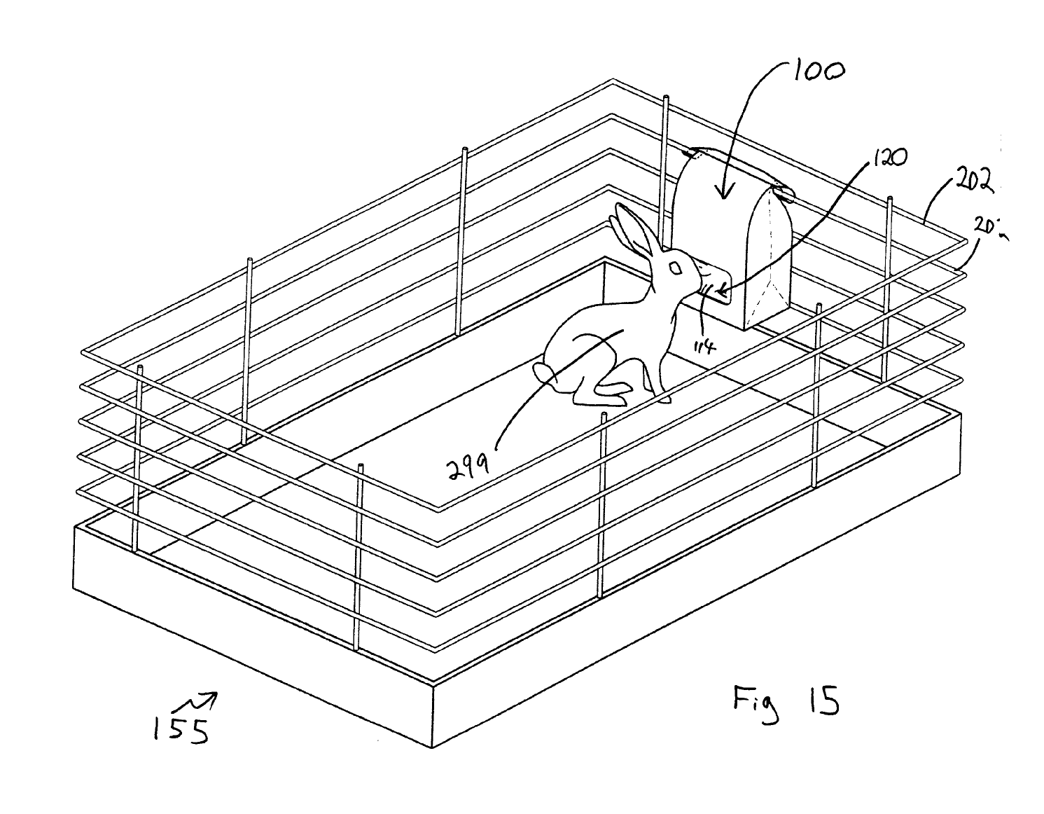

In a further alternative embodiment, shown in FIGS. 14A to 14E, the cover 104 is a tear-away cover 104. The package 102 has a perforated contour 180 defining a central surface 110. The central surface 110 is thereby delineated from the remainder of the package 102 via the perforations 180. The central surface 110 covers the opening 120.

Attached over at least a portion of the central surface 110 of the package 102 is an attachment member 106. The attachment member 106 may, for example, be glued to the central surface 110 so as to provide strength reinforcement over and around the perforations 180 of the package 102.

The cover 104 is removed (as explained below) in order to reveal the opening 120 through which the hay 114 may be accessed.

The procedure for removing the cover 104 according to one embodiment is shown in FIGS. 14B to 14E. Referring to FIG. 14B, a lip 108 extends beyond the central surface 110 of the cover and is not attached directly to the package 102. The lip 108 can, for example be bent away from the package 102 as is shown in FIG. 14C. A user can thus grasp the lip 108 and pull the lip 108 (and hence the central surface 110 which is attached to the lip 108) away from the package 102. In doing so, the package 102 is torn at its perforation 180 to reveal the hay 114 through the opening 120. For example, FIG. 14D shows the cover 104 partially removed from the opening 120 such that a portion of the perforation 180 is torn. To fully remove the cover 104, the entire perforation 180 is torn (see FIG. 14E) by pulling the lip 108 away from the package 102 to completely separate the central surface 110 from the remainder of the package 102.

Once the perforation 180 is torn so as to separate the central surface 110 from the package 102 a contour 117 is left on the package 102 where the package 102 was torn. Similarly, a corresponding contour or ridge 116 remains on the cover 104 around the periphery of the central surface 110 after the cover 104 is torn away from the package 102.

In an alternative embodiment depicted in FIGS. 5 to 8, the opening 120 may be covered by a material strip 502. The strip 502 wraps around the package 102 around its bottom 111 and top, passing over the opening 120. The portion of the strip 502 that passes over the opening 120 includes a transparent central portion 110. At least a part of the transparent central portion 110 lies opposite the opening 120 so that the hay 114 is visible through the transparent central portion 110 and opening 120.

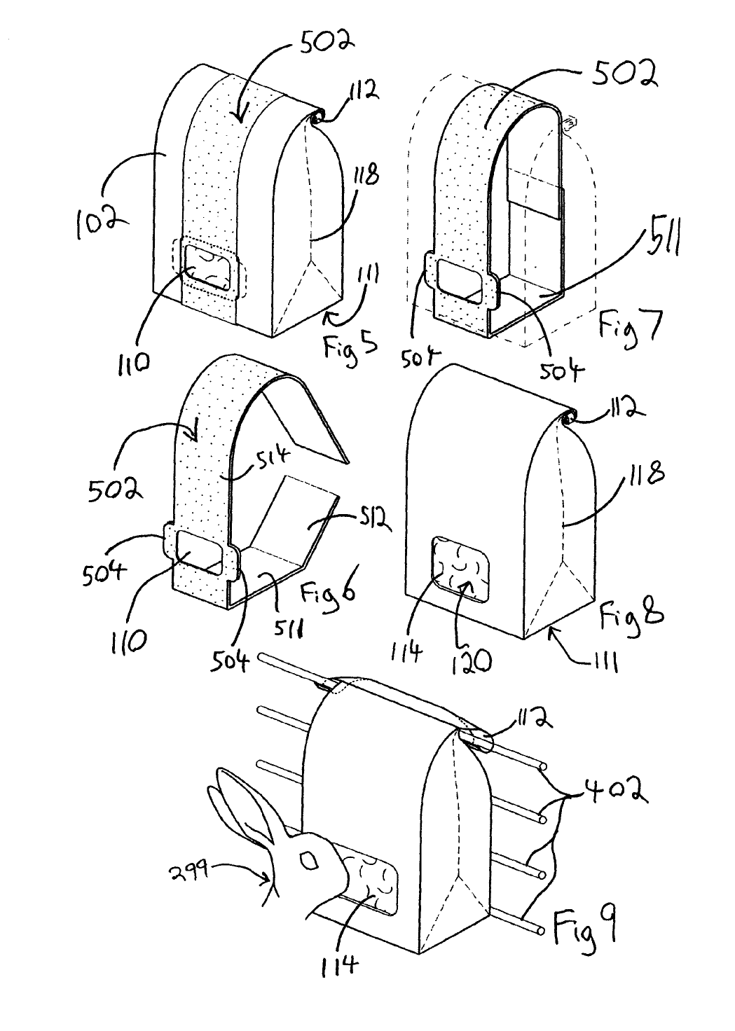

Referring to FIG. 6, the material strip 502 has a flat base 511 for abutting the bottom 111 of the package 102. A back strap 512 and a front strap 514 extend from opposite ends of the flat base 511. Once attached to the package 102 the back strap 512 attaches to the front strap 514 so that the material strip 502 fully circumnavigates the package 102, as shown in FIG. 7 (with the package 102 in dashed lines).

Alternatively, the back strap 512, the front strap 514 and the flat base 511 are all integral on one strap of material and may be demarcated with folded sections of the material.

The strip 502 is secured over the window or opening 120 of the package 502 by a friction fit, an example of which is described as follows. Two ears 504 extend from the material strip 502, one from either side of the transparent central portion 110. According to one embodiment, to secure the material strip 502 to the package 102, the material strip 502 is wrapped around the package 102 so that the bottom 511 of the material strip 502 abuts the bottom 111 of the package 102. The back strap 512 and front strap 514 are then attached together at the back of the package 102 using glue or another similar adhesive (such as a slot and tab arrangement) so that the strip 502 fits snugly around the package 102. The adhesive may be such that the back strap 512 and front strap 514 are removeably attachable to each other. The material strip 502 will then be attached to the package 102 as shown in FIG. 7 (with the package 102 in dashed lines).

Each ear 504 is then slipped into the interior of the package 102 through the opening 120 so as to secure the material strip 502 onto the package 102 (see FIG. 5, for example). Alternatively, the ears 504 may first be slipped into the interior of the package 102 through the opening 120, and then the back strap 512 and front strap 514 may then be attached together in order to secure the material strip 502 onto the package 102.

To remove the material strip 502 package 102, the ears 504 need only to be removed or extracted from the opening 120 and the strip 502 slid off the package 102. The ears 504 may be extracted by squeezing the material strip 502 to force the ears 504 towards one another and them pulling the material strip 502 away from the opening 120. Alternatively, the strip 502 may be slid off the package 102 before the ears 504 are removed or extracted from the opening 120 in order to remove the material strip 502 from the package 102.

In this way the cover is fully removeable from the opening 120 so as not to interfere with access to the contents of the package 102 (e.g. hay 114).

It is recognized that alternative attachment methods (e.g. alternative frictional fits) can secure the strip 502 to the opening 120 of the package 502.

In operation, using the embodiment of the hay dispenser 100 shown in FIGS. 1A to 2, for example, the hay dispenser 100 is filled with hay 114 and then secured to a bar 202 of an enclosure such that the opening 120 is facing the interior of the enclosure. The cover 104 is then removed from the opening 120. Alternatively, the cover 104 is removed from the opening 120 first and then the hay dispenser 100 is secured to the bar 202. At this point the hay 114 inside of the package 102 is accessible to the animal(s) (e.g. a rabbit 299) residing inside of the enclosure. At any time (preferably once all of the hay 114 has been consumed by the rabbit 299) the hay cdispenser 100 may be removed from the bar 202 by unwinding the ribbon 112 from the bar 202 and may thereafter disposed of.

It is recognized that hay 114 is only one example of possible contents of the package 102. Preferably the contents is of a configuration, size, shape or density that the contents will not easily spill out of or be discharged out of the dispenser 100 without an animal (e.g. a rabbit 299) pulling the contents out of the dispenser 100.

One or more currently preferred embodiments have been described by way of example. It will be apparent to persons skilled in the art that a number of variations and modifications can be made without departing from the scope of the invention as defined in the claims.

What is claimed is:

1. An animal food dispenser for dispensing food, comprising:
a package for holding the animal food;
an attachment means secured to the package, the attachment means for attaching the animal food dispenser to an enclosure, the attachment means reconfigurable to adapt to different types of enclosures;
a window through the package; and
a window cover removeably attachable to the package for covering the window, the window cover at least partially removable to provide access through the window to the animal food held in the package.

2. The animal food dispenser of claim 1, wherein the package is a flexible material.

3. The animal food dispenser of claim 1, wherein the package is a rigid material.

4. The animal food dispenser of claim 1, wherein the package is a cardboard box.

5. The animal food dispenser of claim 1, wherein the window cover remains permanently attached to a portion of the package.

6. The animal food dispenser of claim 1, wherein the animal food is hay.

7. The animal food dispenser of claim 1, wherein the window cover comprises a transparent surface, the transparent surface covering at least a portion of the window on the package.

8. The animal food dispenser of claim 1, wherein the window cover is removeably attachable using adhesive.

9. The animal food dispenser of claim 1, wherein the window cover is removable from the package using a perforation in the package.

10. The animal food dispenser of claim 1, wherein the window cover comprises:
a material strip, the material strip circumnavigates the package, the material strip is secured over the window of the package by a friction fit.

11. The animal food dispenser of claim 1, the package having an aperture for receiving the animal food.

12. The animal food dispenser of claim 11, the attachment means at least initially secures the aperture shut.

13. The animal food dispenser of claim 11, the aperture secured shut by adhesive.

14. The animal food dispenser of claim 11 wherein the aperture is resealable using the attachment means.

15. The animal food dispenser of claim 11, wherein the attachment means is a conformable and pliable ribbon.

16. The animal food dispenser of claim 11, wherein the attachment means is a deformable strip attached substantially at the edge of the aperture.

17. The animal food dispenser of claim 1 wherein the enclosure is an animal cage.

18. The animal food dispenser of claim 1 wherein the package is disposable.

19. A method of dispensing animal food from an animal food dispenser, comprising:
providing an animal food dispenser as defined in claim 1;
attaching the package to the interior of the enclosure; and
removing the window cover from the package.

20. The method of claim 19 further comprising removing the package from the interior of the enclosure and disposing of the package.
